(19) United States
(12) Patent Application Publication
(10) Pub. No.: US 2026/0161653 A1
(43) Pub. Date: Jun. 11, 2026

(54) Assigning Weights to a Query's Context for an On-Device Model

(71) Applicant: Google LLC, Mountain View, CA (US)

(72) Inventors: Branden Michael Archer, Mountain View, CA (US); Mekhola Mukherjee, Mountain View, CA (US)

(73) Assignee: Google LLC, Mountain View, CA (US)

(21) Appl. No.: 18/970,803

(22) Filed: Dec. 5, 2024

(51) Int. Cl. G06F 16/2457; G10L 15/16; G10L 15/22

(52) U.S. Cl. CPC G06F 16/24575; G06F 16/24578; G10L 15/16; G10L 15/22; G10L 2015/223

(57) ABSTRACT

A method includes receiving a query and context associated with the query. The method includes determining one or more context components from the context. For each respective context component of the one or more context components, the method includes determining a corresponding priority score based on a relevance of the respective context component to the query and biasing the respective context component based on the corresponding priority score. The method includes generating, using a neural network model, a response based on the query and the biased one or more context components.

### TECHNICAL FIELD

This disclosure relates to assigning weights to a query's context for an on-device model.

### BACKGROUND

In recent years, the development and utilization of large language models (LLMs) have significantly advanced the field of natural language processing, enabling more sophisticated and contextually aware interactions between users and digital assistants. These LLMs are capable of processing and generating human-like text based on textual and audio inputs. However, the effectiveness of the LLMs may be influenced by the context provided with a query. Context may include a variety of components, including but not limited to text, documents, images, audio, and video. Despite the potential richness and diversity of the context, LLMs currently process each component with arbitrary significance. Consequently, LLMs may generate suboptimal responses due to the inability to accurately prioritize the most relevant information in relation to the query. Addressing this challenge is crucial for enhancing the precision and utility of LLMs in diverse applications.

### SUMMARY

One aspect of the disclosure provides a computer-implemented method that when executed on data processing hardware causes the data processing hardware to perform operations for assigning weights to a context of a query. The operations include receiving a query and context associated with the query and determining one or more context components from the context. For each respective context component of the one or more context components, the operations include determining a corresponding priority score based on a relevance of the respective context component for the query and biasing the respective context component based on the corresponding priority score. The operations include generating, using a neural network model, a response based on the query and the biased one or more context components.

Implementations of the disclosure may include one or more of the following optional features. In some implementations, the neural network model includes an automatic speech recognition model or a large language model. The neural network model may reside at a user device. In some examples, the context includes contextual data elements. Each respective contextual data element is associated with a corresponding context modality. In these examples, each respective context component of the one or more context components may include one or more of the contextual data elements each associated with the same corresponding context modality.

In some implementations, for each respective context component of the one or more context components, the operations further include: for each respective context model of a plurality of context models, determining a corresponding intermediate weight based on a respective relevance of the respective context component to the query; and determining a corresponding final weight based on each corresponding intermediate weight determined for the respective context component. Here, the corresponding priority score for the respective context component corresponds to the corresponding final weight. In these implementations, determining the corresponding final weight may include selecting the greatest corresponding intermediate weight determined for the respective context component as the corresponding final weight. Each respective context model may be configured to process a particular type of context modality.

In some examples, the operations further include selecting, from the biased one or more context components, a subset of biased context components based on the corresponding priority score of each respective biased context component. Here, generating the response is further based on the subset of biased context components. In these examples, each respective biased context component in the subset of biased context components may be associated with a corresponding priority score that satisfies a priority score threshold.

Another aspect of the disclosure provides a system that includes data processing hardware and memory hardware storing instructions that when executed on the data processing hardware causes the data processing hardware to perform operations. The operations include receiving a query and context associated with the query and determining one or more context components from the context. For each respective context component of the one or more context components, the operations include determining a corresponding priority score based on a relevance of the respective context component for the query and biasing the respective context component based on the corresponding priority score. The operations include generating, using a neural network model, a response based on the query and the biased one or more context components.

Implementations of the disclosure may include one or more of the following optional features. In some implementations, the neural network model includes an automatic speech recognition model or a large language model. The neural network model may reside at a user device. In some examples, the context includes contextual data elements. Each respective contextual data element is associated with a corresponding context modality. In these examples, each respective context component of the one or more context components may include one or more of the contextual data elements each associated with the same corresponding context modality.

In some implementations, for each respective context component of the one or more context components, the operations further include: for each respective context model of a plurality of context models, determining a corresponding intermediate weight based on a respective relevance of the respective context component to the query; and determining a corresponding final weight based on each corresponding intermediate weight determined for the respective context component. Here, the corresponding priority score for the respective context component corresponds to the corresponding final weight. In these implementations, determining the corresponding final weight may include selecting the greatest corresponding intermediate weight determined for the respective context component as the corresponding final weight. Each respective context model may be configured to process a particular type of context modality.

In some examples, the operations further include selecting, from the biased one or more context components, a subset of biased context components based on the corresponding priority score of each respective biased context component. Here, generating the response is further based on the subset of biased context components. In these examples, each respective biased context component in the subset of biased context components may be associated with a corresponding priority score that satisfies a priority score threshold.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system executing a contextual assistant.

FIG. 2 is a schematic view of an example biasing module of the contextual assistant.

FIG. 3 is a flowchart of an example arrangement of operations for a computer-implemented method of assigning weights to a context of a query.

FIG. 4 is a schematic view of an example computing device that may be used to implement the systems and methods described herein.

Like reference symbols in the various drawings indicate like elements.

### DETAILED DESCRIPTION

Large language models (LLMs) are neural networks that can learn from large amounts of natural language data and perform various natural language tasks, such as answering questions, summarizing texts, generating texts, etc. LLMs receive natural language queries from users and generate natural language responses based on the queries and context provided with the queries. The context may include multiple components, including different modalities such as text, documents, images, audio, video, etc. The context provides useful information that may help the LLM understand the query and generate an appropriate response.

However, not all components of the context are equally relevant or important for the query. Some components of the context are less relevant, or even unimportant or distracting, and may negatively affect the performance of the LLM. For example, the LLM may incorrectly rely on irrelevant or distracting components of the context when determining the final query response or may ignore or overlook relevant components of the context that are buried in the middle of a long context. This problem becomes more challenging as the size and complexity of the context increases. With ever-increasing input size, the potential for irrelevant or distracting information to negatively impact the performance of the LLMs escalates with the scale of the input tokens. Moreover, this problem is particularly critical for on-device LLMs that operate with limited computational power and memory compared to cloud-based LLMs. As such, processing and storing large volumes of irrelevant or distracting context may strain these limited resources, leading to slower response times and increased energy consumption.

Accordingly, implementations herein are directed towards a contextual agent that receives a query and context associated with the query. The contextual assistant determines one or more context components from the context. For each respective context component of the one or more context components, the contextual assistant determines a corresponding priority score based on a relevance of the respective context component to the query and biases the respective context component based on the corresponding priority score. The contextual assistant generates, using a neural network model, a response based on the query and the biased one or more context components.

Advantageously, by biasing the one or more context components the contextual assistant informs the neural network model which context components are more important when generating the response. As such, despite a vast amount of context being input to the neural network model, the contextual assistant enables the neural network model to focus on the important context components. Moreover, in scenarios where the neural network model resides on a user device, the contextual assistant may filter context components based on the priority scores. That is, the contextual assistant may discard context components that have priority scores that fail to satisfy a threshold (e.g., that are not relevant to the query) such that the neural network model only receives the context components that have priority scores that satisfy the threshold.

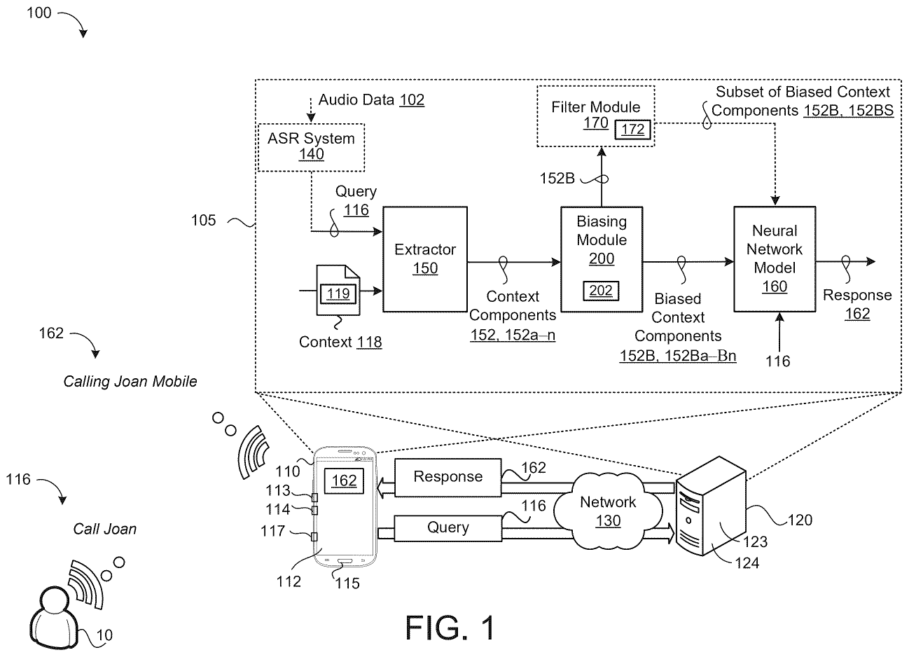

FIG. 1 illustrates an example system 100 including a contextual assistant 105 that allows users 10 to interact with a neural network model 160 to perform actions on behalf of the user 10. Generally, the user 10 inputs, via a user device 110, a natural language query 116 specifying a task to be performed on behalf of the user 10. The neural network model 160 performs the task specified by the natural language query 116 and generates a response 162 for the query 116. In some implementations, the neural network model 160 includes an automatic speech recognition (ASR) model such that the response 162 generated by the neural network model 160 includes a transcription of the natural language query 116 spoken by the user 10. In other implementations, the neural network model 160 includes a large language model (LLM) such that the neural network model 160 performs the task specified by the natural language query 116 and generates the response 162 based on performing the task.

The system 100 includes the user device 110, a remote computing system 120, and a network 130. The user device 110 includes data processing hardware 113 and memory hardware 114. The user device 110 may include, or be in communication with, an audio capture device 115 (e.g., an array of one or more microphones) for converting utterances of natural language queries 116 spoken by the user 10 into corresponding audio data 102 (e.g., electrical signals or digital data). In lieu of spoken input, the user 10 may input a textual representation of the natural language query (e.g., query) 116 via a user interface executing on the user device 110. The user device 110 may include a screen 112 that displays the response 162 to the user 10. In some examples, the user device 110 includes an audio output device 117 that audibly synthesizes the responses as output from the audio output device 117. That is, the user device 110 may synthesize speech based on the response and audibly output the synthesized speech via the audio output device 117.

In scenarios when the user 10 speaks a natural language query 116 captured by the microphone 115 of the user device 110, an automated speech recognition (ASR) system 140 executing on the user device 110 or the remote computing system 120 may process the corresponding audio data 102 to generate a transcription of the query 116. Here, the transcription conveys the natural language query 116 as a textual representation. The ASR system 140 may implement any number and/or type(s) of past, current, or future speech recognition systems, models, and/or methods including, but not limited to, an end-to-end speech recognition model, such as streaming speech recognition models having recurrent neural network-transducer (RNN-T) model architectures, a hidden Markov model, an acoustic model, a pronunciation model, a language model, and/or a naïve Bayes classifier.

The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches).

The remote computing system 120 may be a distributed system (e.g., a cloud computing environment) having scalable elastic resources. The resources include computing resources 123 (e.g., data processing hardware) and/or storage resources 124 (e.g., memory hardware). Additionally or alternatively, the remote computing system 120 may be a centralized system. The network 130 may be wired, wireless, or a combination thereof, and may include private networks and/or public networks, such as the Internet.

With continued reference to FIG. 1, the contextual assistant 105 includes the ASR system 140, an extractor 150, the neural network model 160, and a biasing module 200. The ASR system 140 may be optional or only leveraged when the user 10 prefers spoken input of natural language queries 116 as opposed to typed input. In some implementations, the contextual assistant 105 executes on both the data processing hardware 113 of the user device 110 and the data processing hardware 123 of the remote computing system 120. For instance, one or more components of the contextual assistant 105 may execute on the data processing hardware 113 of the user device 110 while one or more other components of the contextual assistant 105 may execute on the remote computing system 120. In some examples, all of the components of the contextual assistant 105 execute on the user device 110 whereby the data processing hardware 113 and memory hardware 114 are limited as compared to the data processing hardware 123 and the memory hardware 124 of the remote computing system 120.

The extractor 150 is configured to receive the query 116 and context 118 associated with the query 116 and determine one or more context components 152, 152a-n from the context 118. The context 118 includes contextual data elements 119 whereby each respective contextual data element 119 is associated with a corresponding context modality. For instance, the contextual data elements 119 may be associated with audio, text, video, and/or document context modalities. The contextual data elements 119 may include any information related to the query 116. For example, the contextual data elements 119 may include, but are not limited to, a wide range of contextual data, such as the time of day, the location of the user device 110, the recent activity of the user device 110, and any other environmental or external factors that may influence the query 116. For example, the context 118 for the query 116 of “What is the weather like?” may indicate that the user device 110 is located in New York City at 8 AM. Moreover, in this example, the context 118 may further indicate that the user 10 has recently searched for information regarding outdoor events thereby suggesting that the user 10 may be interested in the weather for planning purposes.

In some implementations, the context 118 indicates the intent by the user 10 for the query 116. The intent may be discerned from the phrasing of the query 116, the tone of voice of the user 10 (if the query is spoken), and other contextual cues. For instance, the query 116 of “Do I need an umbrella today?” may suggest a concern about potential rain. If the query 116 is spoken with urgency, it may indicate that the user 10 is about to leave their current location and needs immediate information. Additionally, the context 118 may include historical data about the past queries and behavior patterns of the user 10. For example, if the user 10 frequently checks the weather before commuting, the contextual assistant 105 may infer that the user 10 is likely interested in the weather conditions for a commute. In some implementations, the contextual assistant 105 receives the context 118 along with the query 116. In other implementations, the contextual assistant 105 only receives the query 116 and determines the context 118 based on the query 116. Here, the contextual assistant 105 may obtain the context 118 from one or more data sources. For example, for the query 116 of “Do I need an umbrella today?” the contextual assistant 105 may obtain the context 118 of a location of the user device 110 from a data source.

In some examples, the extractor 150 determines the one or more context components 152 by separating different context modalities from the context 118 into separate context components 152. As discussed above, context modalities may include text, audio, video, and documents. By separating different context modalities from the context 118 into separate context components 152, the extractor 150 allows each context modality to be processed by the contextual assistant 105 independently from other context modalities. Thus, each respective context component 152 of the one or more context components 152 may include one or more of the contextual data elements 119 each of which is associated with the same corresponding context modality. For example, the context 118 may include a first contextual data element 119 that includes text, a second contextual data element 119 that includes text, and a third contextual data element 119 that includes an image. In this example, the extractor 150 may determine a first context component 152 that includes the first and second contextual data elements 119 (e.g., the contextual data elements 119 including text) and a second context component 152 that includes the third contextual data element 119 (e.g., the contextual data element 119 including the image). By grouping contextual data elements 119 with the same context modalities, the extractor 150 enables contextual data elements 119 of the same context modality to be processed together.

In some implementations, the extractor 150 determines the one or more context components 152 by combining one or more contextual data elements 119 into a single context component 152. Here, the extractor 150 may combine contextual data elements 119 into a single context component 152 based on metadata of the contextual data elements 119. For instance, the extractor 150 may combine or group contextual data elements 119 with the same or similar metadata into a single context component 152. For example, if the context 118 includes a first and second contextual data elements 119 that are images with similar metadata (e.g., timestamp or location image was taken), the extractor 150 may group the first and second contextual data elements 119 into a single context component 152. Continuing with the example, if the context 118 further includes a third contextual data element 119 that includes an image with different metadata than the first and second contextual data elements 119, the extractor 150 may assign the third contextual data element 119 into another context component 152 despite being of the same context modality as the first and second contextual data elements 119. Grouping contextual data elements 119 of the context 118 together based on metadata of the contextual data elements 119 allows the extractor 150 to reduce the number of context components 152 and to capture relationships among the contextual data elements 119, such as semantic or temporal relationships. For example, the extractor 150 may use metadata or image similarity to group x-ray images together, as the x-ray images may represent different views or stages of a medical condition or procedure.

In some implementations, the extractor 150 determines the one or more context components 152 by determining the relevance between each contextual data element 119 and the query 116. For instance, the extractor 150 may determine the relevance of a contextual data element 119 including a section of text to the query 116. For example, if the contextual data element 119 includes a paragraph of text, the extractor 150 may evaluate how closely the text matches the query 116 based on some relevance criteria. The relevance criteria may include the presence of query terms, the similarity of query and text semantics, or the specificity of query 116 and text concepts. Thereafter, the extractor 150 may group contextual data elements 119 with similar determined relevancies to the query 116. Grouping contextual data elements 119 with similar relevancies allows the extractor 150 to prioritize the more relevant contextual data elements 119 for further processing.

In some examples, the extractor 150 determines the one or more context components 152 based on a timestamp associated with the origination of the contextual data elements 119. Here, the extractor 150 considers the time passed from the origin of the contextual data element 119. For example, if the context 118 includes user-generated content, such as social media posts, the extractor 150 may consider the recency or freshness of the content, as it may affect the relevance or accuracy of the content to the query 116. The timestamp associated with the origination of the contextual data elements 119 allows the extractor 150 to decompose the content into context components 152 that reflect the temporal dynamics of the context 118 and to update the context components 152 as new content becomes available.

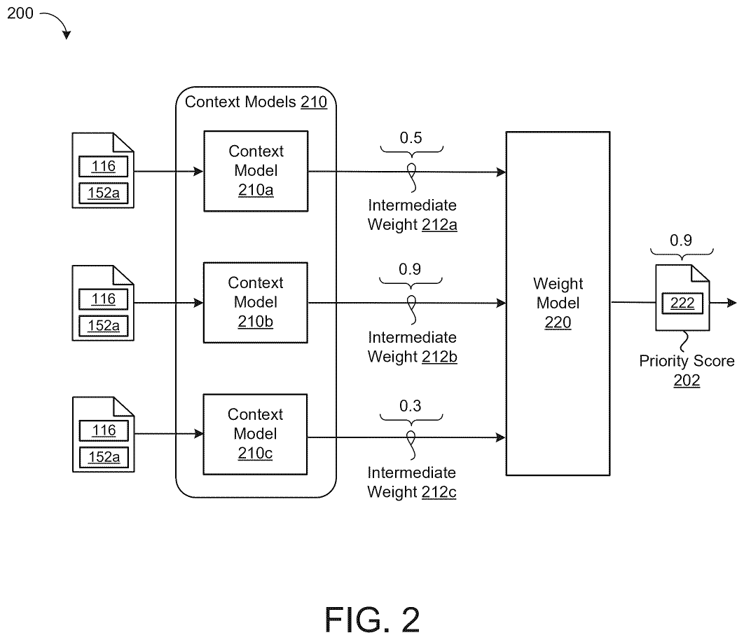

As discussed in greater detail with reference to FIG. 2, for each respective context component 152 of the one or more context components 152, the biasing module 200 determines a corresponding priority score 202 based on a relevance of the respective context component 152 to the query and biases the respective context component 152 based on the corresponding priority score 202. That is, initially each context component 152 may be associated with a predetermined priority score 202 shared among all of the context 118. By biasing each respective context component 152 based on the corresponding priority score 202, the biasing module 200 informs the neural network model 160 which context components 152 are most relevant to the query 116.

The priority score 202 reflects the degree of importance or relevance of the respective context component 152 on the query 116. Thus, the priority scores 202 may depend on various factors, such as the type, recency, frequency, or location of the context components 152, as well as the user preferences, profile, or feedback. For example, a context component 152 that is of the same type as the query 116, such as a text message, an email, or a voice command, may have a higher priority score 202 than a context component 152 that is of a different type, such as a calendar event, a weather report, or a news article. Similarly, a context component 152 that is more recent, more frequent, or more relevant to the query 116 may have a higher priority score 202 than a context component 152 that is older, less frequent, or less relevant to the query 116. Additionally, the user 10 may indicate their preferences, profile, or feedback regarding the context components 152. For instance, the user 10 may select, rate, or comment on the different types of context components 152, which may also affect the priority score 202.

The priority score 202 may be a numerical value that represents the degree of importance or influence of the respective context component 152 on the query 116. For example, a priority score 202 of ‘1’ may indicate the highest priority or relevance, while a priority score 202 of ‘0’ may indicate the lowest relevance or priority, and so on. Alternatively, the priority score 202 may be a categorical value that indicates a rank or a level of relevance or priority, such as high, medium, low, or none. In yet other examples, the priority score 202 may be a relative score based on the priority scores 202 of each other context component 152. For instance, with five (5) context components 152, the priority score 202 may be a numerical value between ‘1’ and ‘5’ whereby each context component 152 has a different priority score 202. Thus, the priority score 202 of each context component 152 situates the importance or relevance of that context component as compared to the other context components 152.

For each respective context component 152 of the one or more context components 152, the biasing module 200 biases the respective context component 152 based on the corresponding priority score 202 determined for the respective context component 152 to generate a corresponding biased context component 152, 152B. The biasing module 200 outputs the biases one or more context components 152B, 152Ba-n to the neural network model 160. As such, the contextual assistant 105 gives more weight or attention to context components 152 with higher priority scores 202 and less weight or attention to context components 152 with lower priority scores 202 when generating the response 162 to the query 116.

Thereafter, the neural network model 160 generates a response 162 to the query 116 based on processing the query 116 and the biased one or more context components 152B. The neural network model 160 gives more weight or attention to context components 152 with higher priority scores 202 and less weight or attention to context components 152 with lower priority scores 202 when generating the response 162 to the query 116. The contextual assistant 105 may transmit the response 162 to the user device 110 and display the response 162 on the screen 112 of the user device 110 and/or audibly output the response 162 via the audio output device 117.

In the example shown, the user 10 speaks the query 116 of “Call Joan” whereby the contextual assistant 105 obtains context 118 based on the query 116. The context 118 includes a first contextual data element 119 of audio data of previous queries spoken by the user 10 and a second contextual data element 119 of text data of contact names of the user 10. The extractor 150 determines a first context component 152 including the first contextual data element 119 of the context 118 and a second context component 152 including the second contextual data element 119 of the context 118. That is, the extractor 150 separates the audio data into the first context component 152 and the text data into the second context component 152. The biasing module 200 determines a corresponding priority score 202 based on the relevance of each respective context component 152 to the query 116. In the example shown, the biasing module 200 determines a corresponding priority score 202 for the first context component 152 and a corresponding priority score 202 for the second context component 152 indicating that the audio data of previous queries is less relevant to the query 116 than the text data of contact names.

Thus, the biasing module 200 biases the context components 152 based on the corresponding priority scores 202 to generate the biased context components 152B. Finally, the neural network model 160 processes the query 116 and the biased context components 152B to generate the response 162 of “Calling Joan Mobile.” Here, the neural network model 160 may be an assistant-based LLM that weights the text data of the contact names more than the audio data of the previous queries when processing the query 116 of “Call Joan” to determine the task of ‘calling Joan’ and performing the determined task.

In some configurations, the neural network model 160 has an input token limit that restricts the amount of input the neural network model 160 may process. Consequently, the neural network model 160 may be unable to process the query 116 and all of the biased context components 152B. The constraint is even more profound when the neural network model 160, and other components of the contextual assistant 105, reside at the user device 110 because of the limited data processing hardware 113 of the user device 110 as compared to the data processing hardware 123 of the remote computing system 120.

To that end, the contextual assistant 105 may optionally include a filter module 170. The filter module 170 is configured to select a subset of biased context components 152B, 152BS from the biased one or more context components 152B based on the corresponding priority score of each respective biased context component. That is, for each respective biased context component 152B of the biased one or more context components 152B, the filter module 170 may determine whether the corresponding priority score 202 of the biased context component 152B satisfies a priority score threshold 172. The filter module 170 may discard biased context components 152B with corresponding priority scores 202 that fail to satisfy the priority score threshold 172. Moreover, the filter module 170 may select biased context components 152B with corresponding priority scores 202 that satisfy the priority score threshold 172. Thus, the neural network model 160 may generate the response based on processing the query 116 and the subset of biased context components 152BS in lieu of the biased one or more context components 152B. By using the subset of biased context components 152BS instead of the biased one or more context components 152B to generate the response 162, the neural network model 160 is able to reduce the amount of input to the neural network model 160 while maintaining the most relevant context components 152. Accordingly, by still processing the relevant context components 152, the neural network model 160 generates accurate response 162 and reduces the amount of input being processed by using the subset of biased context components 152BS.

Referring now to FIG. 2, in some implementations, the biasing module 200 includes a plurality of context models 210 and a weight model 220. Each context model 210 of the plurality of context models 210 may be configured to process a particular type of context modality. For instance, each context model 210 may be configured to process at least one of a query context modality, a text context modality, an image context modality, a document context modality, or a video context modality. The context model 210 may include a deterministic model programmed for the particular context modality or a neural network model trained on the particular context modality. For instance, one context model may include a neural network model trained on medical imaging data while another context model includes another neural network model trained to recognize speech utterances. The context model 210 may include a neural network model such as a large language model that is the same or different than the neural network model 160 that receives the biased context components 152B. Regardless of the context modality, each context model 210 is configured to determine a corresponding intermediate weight 212 based on a respective relevance of the respective context component 152 to the query 116. Each context model 210 determines the corresponding intermediate weight 212 for each respective context component 152. The intermediate weight 212 represents a relevance (e.g., as determined by the corresponding context model 210) of the context component 152 to the query 116. As such, each context model 210 may determine a different corresponding intermediate weight 212 between the same query 116 and context component 152.

In the example shown, the plurality of context models 210 includes three context models 210, 210a-c for the sake of clarity only as the plurality of context models 210 may include any number of context models 210. The first context model 210a is configured to process documents, the second context model 210b is configured to process text, and the third context model 210c is configured to process images. Each context model 210 receives the query 116 and the same first context component 152a. In this example, the first context component 152 includes a contextual data element 119 of text data of contact names associated with a user 10 and the query 116 is “Call Joan.” To that end, the first context model 210a determines a corresponding intermediate weight 212a based on a respective relevance of the respective context component 152a to the query 116. Since the first context model 210a is configured to process documents, the first context model 210a is moderately confident that the context component 152 is related to the query 116 and generates the intermediate weight of “0.5.” The second context model 210b determines a corresponding intermediate weight 212b based on a respective relevance of the respective context component 152a to the query 116. Here, the second context model 210b is configured to process text, and thus, the second context model 210b is fairly confident that the context component 152 is related to the query 116 and generates the intermediate weight of “0.9.” The third context model 210c determines a corresponding intermediate weight 212c based on a respective relevance of the respective context component 152a to the query 116. Here, the third context model 210b is configured to process images, and thus, the third context model 210c is not confident that the context component 152 is related to the query 116 and generates the intermediate weight of “0.3.”

The weight model 220 determines a corresponding final weight 222 based on each corresponding intermediate weight 212 determined for the respective context component 152. In some examples, the weight model 220 determines the corresponding final weight 222 for the respective context component 152a by selecting the intermediate weight 212 having the greatest corresponding intermediate weight 212 determined for the respective context component 152 as the corresponding final weight 222. In other examples, the weight model 220 determines the corresponding final weight 222 for the respective context component 152a by selecting the intermediate weight 212 having the lowest corresponding intermediate weight 212 determined for the respective context component 152 as the corresponding final weight 222. In yet other examples, the weight model 220 determines the corresponding final weight 222 for the respective context component 152a by averaging all of the intermediate weights 212 together such that the average serves as the corresponding final weight 222. The corresponding priority score 202 for the respective context component corresponds (i.e., is equal to) the corresponding final weight 222. Continuing with the example shown, the weight model 220 receives the first intermediate weight 212a of “0.5,” the second intermediate weight 212b of “0.9,” and the third intermediate weight 212c of “0.3” and selects the greatest corresponding intermediate weight of “0.9” as the final weight 222 for the context component 152a. The final weight 222 may serve as the priority score 202 of the respective context component 152.

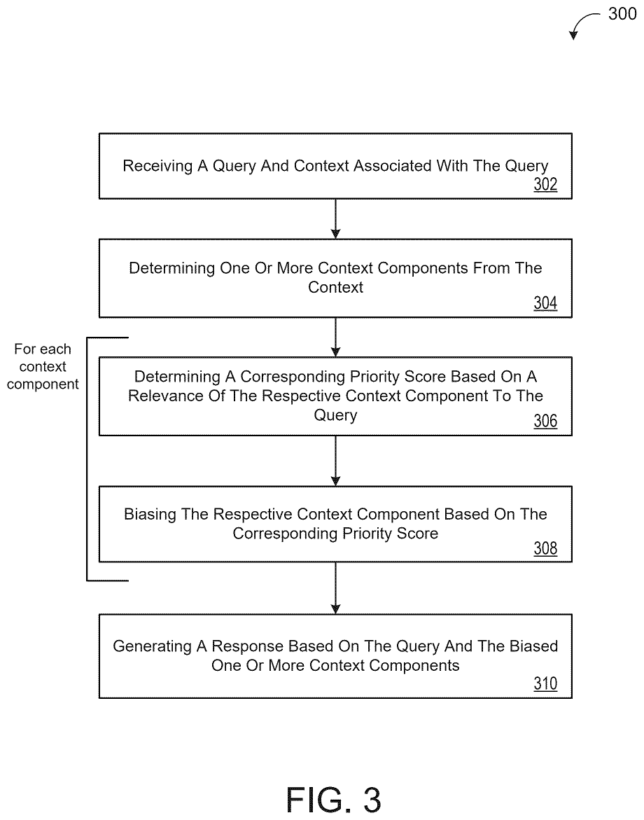

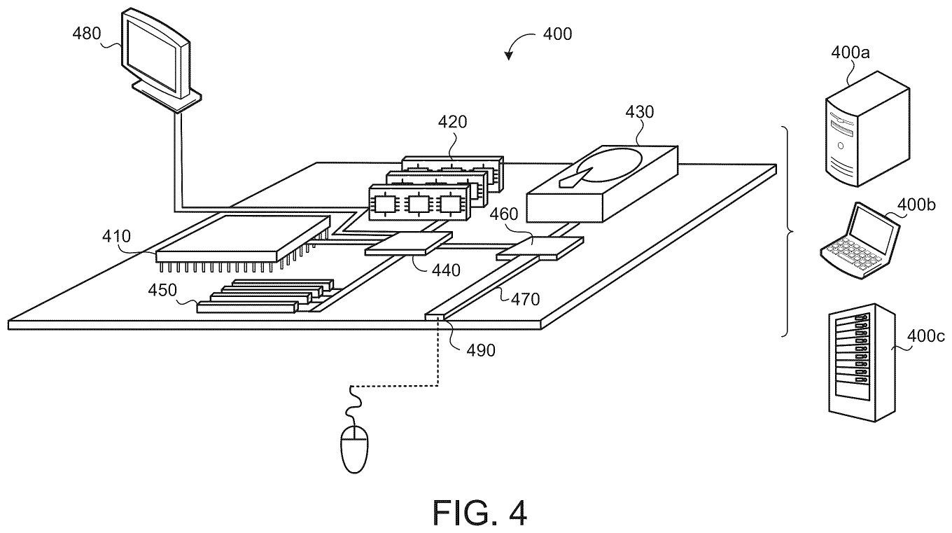

FIG. 3 illustrates a flowchart of an example arrangement of operations for a computer-implemented method 300 of assigning weights to a context of a query. The method 300 may execute on data processing hardware 410 (FIG. 4) using instructions stored on memory hardware 420 (FIG. 4). The data processing hardware 410 and the memory hardware 420 may reside on the user device 110 and/or the remote computing system 120 of FIG. 1 each corresponding to a computing device 400 (FIG. 4).

At operation 302, the method 300 includes receiving a query 116 and context 118 associated with the query 116. At operation 304, the method 300 includes determining one or more context components 152 from the context 118. For each respective context component 152 of the one or more context components 152, the method 300 performs operations 306 and 308. At operation 306, the method 300 includes determining a corresponding priority score 202 based on a relevance of the respective context component 152 to the query 116. At operation 308, the method 300 includes biasing the respective context component 152 based on the corresponding priority score 202. At operation 310, the method 300 includes generating, using a neural network model 160, a response 162 based on the query 116 and the biased one or more context components 152, 152B.

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user, for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A computer-implemented method executed on data processing hardware that causes the data processing hardware to perform operations comprising:
receiving a query and context associated with the query;
determining, from the context, two or more context components;
for each respective context component of the one or more context components:
determining a corresponding priority score based on a relevance of the respective context component to the query, the corresponding priority score determined for the respective context component indicating relevance of the respective context component compared to each other context component of the two or more context components; and
biasing the respective context component by weighting the respective context component based on a value of the corresponding priority score; and
generating, using a neural network model, a response based on the query and the biased two or more context components.

2. The method of claim 1, wherein the neural network model comprises an automatic speech recognition model or a large language model.

3. The method of claim 1, wherein the neural network model resides at a user device.

4. The method of claim 1, wherein the context comprises contextual data elements, each respective contextual data element associated with a corresponding context modality.

5. The method of claim 4, wherein each respective context component of the one or more context components comprises one or more of the contextual data elements each associated with the same corresponding context modality.

6. The method of claim 1, wherein the operations further comprise, for each respective context component of the one or more context components:
for each respective context model of a plurality of context models, determining a corresponding intermediate weight based on a respective relevance of the respective context component to the query; and
determining a corresponding final weight based on each corresponding intermediate weight determined for the respective context component,
wherein the corresponding priority score for the respective context component corresponds to the corresponding final weight.

7. The method of claim 6, wherein determining the corresponding final weight comprises selecting the greatest corresponding intermediate weight determined for the respective context component as the corresponding final weight.

8. The method of claim 6, wherein each respective context model is configured to process a particular type of context modality.

9. The method of claim 1, wherein the operations further comprise:
selecting, from the biased one or more context components, a subset of biased context components based on the corresponding priority score of each respective biased context component,
wherein the generating the response is further based on the subset of biased context components.

10. The method of claim 9, wherein each respective biased context component in the subset of biased context components is associated with a corresponding priority score that satisfies a priority score threshold.

11. A system comprising:
data processing hardware; and
memory hardware in communication with the data processing hardware, the memory hardware storing instructions that when executed on the data processing hardware cause the data processing hardware to perform operations comprising:
receiving a query and context associated with the query;
determining, from the context, two or more context components;
for each respective context component of the one or more context components:
determining a corresponding priority score based on a relevance of the respective context component to the query, the corresponding priority score determined for the respective context component indicating relevance of the respective context component compared to each other context component of the two or more context components; and
biasing the respective context component by weighting the respective context component based on a value of the corresponding priority score; and
generating, using a neural network model, a response based on the query and the biased two or more context components.

12. The system of claim 11, wherein the neural network model comprises an automatic speech recognition model or a large language model.

13. The system of claim 11, wherein the neural network model resides at a user device.

14. The system of claim 11, wherein the context comprises contextual data elements, each respective contextual data element associated with a corresponding context modality.

15. The system of claim 14, wherein each respective context component of the one or more context components comprises one or more of the contextual data elements each associated with the same corresponding context modality.

16. The system of claim 11, wherein the operations further comprise, for each respective context component of the one or more context components:
for each respective context model of a plurality of context models, determining a corresponding intermediate weight based on a respective relevance of the respective context component to the query; and
determining a corresponding final weight based on each corresponding intermediate weight determined for the respective context component,
wherein the corresponding priority score for the respective context component corresponds to the corresponding final weight.

17. The system of claim 16, wherein determining the corresponding final weight comprises selecting the greatest corresponding intermediate weight determined for the respective context component as the corresponding final weight.

18. The system of claim 16, wherein each respective context model is configured to process a particular type of context modality.

19. The system of claim 11, wherein the operations further comprise:
selecting, from the biased one or more context components, a subset of biased context components based on the corresponding priority score of each respective biased context component,
wherein the generating the response is further based on the subset of biased context components.

20. The system of claim 19, wherein each respective biased context component in the subset of biased context components is associated with a corresponding priority score that satisfies a priority score threshold.
